(19) United States
(12) Patent Application Publication
(10) Pub. No.: US 2024/0176154 A1
(43) Pub. Date: May 30, 2024

(54) HEADLAMP AIMING ADJUSTMENT SYSTEM FOR A MOBILITY DEVICE AND A CONTROLLING METHOD FOR THE SAME

(71) Applicants: HYUNDAI MOTOR COMPANY, Seoul (KR); KIA CORPORATION, Seoul (KR)

(72) Inventor: Sung Ho Park, Seoul (KR)

(73) Assignees: HYUNDAI MOTOR COMPANY, Seoul (KR); KIA CORPORATION, Seoul (KR)

(21) Appl. No.: 18/197,307

(22) Filed: May 15, 2023

(30) Foreign Application Priority Data
Nov. 29, 2022 (KR) 10-2022-0162848

(51) Int. Cl. G02B 27/01; B60Q 1/08; F21S 41/60; G06F 3/01; G06T 7/70; G06V 20/58

(52) U.S. Cl. CPC G02B 27/0179; B60Q 1/085; F21S 41/60; G02B 27/0101; G06F 3/013; G06T 7/70; G06V 20/58; B60K 35/00; B60Q 2300/23; B60Q 2300/45; B60Q 2400/50; G02B 2027/0183; G02B 2027/0187; G06T 2207/30201; G06T 2207/30268

(57) ABSTRACT

Proposed are a headlamp aiming adjustment system and method for a mobility device, the system and method being capable of improving visibility of messages transmitted through a headlamp and a head-up display (HUD) by adjusting an emitting position of light emitted from the headlamp and a position of an information image displayed through the HUD according to a driver's eye position.

### CROSS REFERENCE TO RELATED APPLICATION

The present application claims priority to Korean Patent Application No. 10-2022-0162848, filed Nov. 29, 2022, the entire contents of which are incorporated herein by reference.

### BACKGROUND

### Field

The present disclosure relates to a headlamp aiming adjustment system and method for a mobility device, the system and method being capable of improving visibility of light emitted from a headlamp by adjusting an emitting position of light emitted from the headlamp.

### Description of the Related Art

In general, a mobility device is equipped with a lighting device for enabling visibility of objects in a driving direction during night driving and for notifying other vehicles or other road users of a driving state of the mobility device. A headlamp is a lighting lamp that functions to illuminate a road ahead of a vehicle.

In other words, the headlamp emits light in the driving direction of the mobility device during driving and helps ensure safe driving by increasing visibility and detecting the presence of other vehicles and objects on the road.

Recently, projection headlamps that prevent glare to oncoming vehicles and pedestrians by adjusting the aiming of the headlamp, or deliver messages using beam patterns on the road surface, are being applied for the convenience and driving safety of oncoming vehicles and pedestrians.

However, since the function of the projection headlamps is limited to only adjusting a light emitting position with respect to oncoming vehicles and pedestrians, not the driver's field of view, the driver may not accurately recognize a light image projected on the road surface.

In addition, the position of the driver's field of view is changed depending on the driver's physical condition because different drivers are in different physical conditions, but the light emitting position of the headlamp does not consider the driver's physical condition.

The foregoing is intended merely to aid in the understanding of the background of the present disclosure, and is not intended to mean that the present disclosure falls within the purview of the related art that is already known to those having ordinary skill in the art.

### SUMMARY

The present disclosure has been made keeping in mind the above problems occurring in the related art, and the present disclosure provides a headlamp aiming adjustment system for a mobility device and a controlling method for the headlamp aiming adjustment system. The system and method improve visibility of light emitted from a headlamp by adjusting an emitting position of light emitted from the headlamp according to a driver's eye position.

In order to achieve the above objective, according to one aspect of the present disclosure, there is provided a headlamp aiming adjustment system for a mobility device. The system includes: a camera sensing part configured to detect a driver's eye position; a projection headlamp configured to emit light to form a projection image on a road surface and to adjust a position of the projection image; and a controller configured to control the projection headlamp to adjust the position of the projection image of the projection headlamp by receiving the driver's eye position through the camera sensing part and calculating the position of the projection image according to an amount of change in the driver's eye position.

The controller may calculate the position of the projection image of the projection headlamp according to the amount of change in the driver's eye position when the driver's eye position is out of a set range for equal to or longer than a set time.

The controller may further receive information about a seat position, and when it is determined that the seat position is changed, the controller may calculate the position of the projection image of the projection headlamp according to the amount of change in the driver's eye position.

The controller may store the driver's eye position before an ignition of the mobility device is turned off (i.e., ignition OFF), and when the driver's eye position upon ignition ON (i.e., the ignition is turned on) is different from the previously stored driver's eye position, the controller may calculate the position of the projection image of the projection headlamp according to the amount of change in the driver's eye position.

The controller may derive a virtual line connecting the driver's eye position and the position of the projection image, and when the virtual line is at a position where the virtual line interferes with a front part of the mobility device, the controller may calculate the position of the projection image of the projection headlamp.

The system may further include a head-up display (HUD) configured to display an informational image in front of a driver's field of view. The controller may further determine whether positions of the information image of the HUD and the projection image of the projection headlamp overlap at a viewing angle according to the driver's eye position.

When the positions of the information image and the projection image overlap at the viewing angle according to the driver's eye position, the controller may calculate an amount of overlap between the information image and the projection image and control the HUD and the projection headlamp so that the amount of overlap is out of a minimum overlap range.

When controlling the HUD and the projection headlamp on the basis of the calculated amount of overlap, the controller may first adjust the position of the projection image of the projection headlamp, and then when the amount of overlap is not out of the minimum overlap range even when the position of the projection image is adjusted, the controller may adjust the position of the information image of the HUD.

The controller may calculate the position of the projection image of the projection headlamp according to the amount of change in the driver's eye position when the mobility device is stopped or driven at a speed less than a set speed.

The controller may correct the position of the projection image of the projection headlamp by dividing a driving speed of the mobility device into a low-speed section and a high-speed section during driving.

When the mobility device is driven in the low-speed section, the controller may receive sensing information through an external sensing part that is configured to detect an object and a pedestrian around the mobility device, and calculate the position of the projection image of the projection headlamp according to positions of the detected object and pedestrian.

When the mobility device is driven in the low-speed section, the controller may perform decreasing correction so that the position of the projection image becomes closer to the mobility device.

When the mobility device is driven in the high-speed section, the controller may perform increasing correction so that the position of the projection image becomes farther away from the mobility device as the driving speed of the mobility device increases.

According to another aspect of the present disclosure, there is provided a headlamp aiming adjustment method for a mobility device. The method includes: a first determining step of determining a driver's eye position and determining whether the driver's eye position is changed; a second determining step of determining a position of a projection image emitted from a projection headlamp; a calculating step of calculating the position of the projection image according to an amount of change in the driver's eye position when it is determined that the driver's eye position is changed; and a controlling step of controlling the projection headlamp to emit light to the calculated position of the projection image.

The first determining step may be performed by determining that the driver's eye position is changed when the driver's eye position is out of a set range for equal to or longer than a set time.

The first determining step may be performed by further receiving information about a seat position, and when determining that the seat position is changed, determining that the driver's eye position is changed.

The first determining step may be performed by storing the driver's eye position before ignition OFF, and when the driver's eye position upon ignition ON is different from the previously stored driver's eye position, determining that the driver's eye position is changed.

The calculating step may be performed by deriving a virtual line connecting the driver's eye position and the position of the projection image, and when the virtual line is at a position where the virtual line interferes with a front part of the mobility device, calculating the position of the projection image of the projection headlamp so that the virtual line does not interfere with the front part of the mobility device.

The method may further include a third determining step of determining a position of an information image displayed through a HUD. The calculating step may be performed by when positions of an information image and the projection image overlap at a viewing angle according to the driver's eye position, calculating an amount of overlap to be out of a minimum overlap range.

The method may further include a fourth determining step of receiving driving speed information of the mobility device and determining whether the driving speed of the mobility device is in a low-speed section or a high-speed section. The calculating step may be performed by when the mobility device is driven in the low-speed section, performing decreasing correction so that the position of the projection image becomes closer to the mobility device.

The calculating step may be performed by when the mobility device is driven in the high-speed section, performing increasing correction so that the position of the projection image becomes farther away from the mobility device as the driving speed of the mobility device increases.

According to the headlamp aiming adjustment system and method for the mobility device having the configuration as described above, by adjusting the emitting position of light emitted from the projection headlamp and the position of the information image displayed through the HUD according to the driver's eye position, it is possible to achieve improved visibility of messages delivered through the projection headlamp and the HUD.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view illustrating the configuration of a headlamp aiming adjustment system for a mobility device according to an embodiment of the present disclosure;

FIG. 2 is a view illustrating a projection image and an information image emitted from a projection headlamp and a HUD of the headlamp aiming adjustment system for the mobility device illustrated in FIG. 1;

FIG. 3 is a view illustrating the headlamp aiming adjustment system for the mobility device in an embodiment of the present disclosure;

FIG. 4 is a flowchart illustrating a headlamp aiming adjustment method for a mobility device according to an embodiment of the present disclosure;

FIG. 5 is a flow chart illustrating an embodiment of the headlamp aiming adjustment method for the mobility device illustrated in FIG. 4;

FIG. 6 is a flowchart illustrating another embodiment of the headlamp aiming adjustment method for the mobility device illustrated in FIG. 4; and

FIG. 7 is a flowchart illustrating another embodiment of the headlamp aiming adjustment method for the mobility device illustrated in FIG. 4.

### DETAILED DESCRIPTION

Hereinafter, embodiments disclosed in the present disclosure are described in detail with reference to the accompanying drawings, in which identical or similar constituent elements are given the same reference numerals regardless of the reference numerals of the drawings, and repeated descriptions thereof have been omitted.

The component suffixes “module” and “part” used in the following description are given or mixed together only considering the ease of creating the specification, and have no meanings or roles that are distinguished from each other by themselves.

In the description of the present disclosure, when it is determined that the detailed description of the related art would obscure the gist of the present disclosure, the detailed descriptions thereof have been omitted. In addition, the accompanying drawings are merely intended to be able to readily understand the embodiments disclosed herein, and thus the technical idea disclosed herein is not limited by the accompanying drawings, and it should be understood to include all changes, equivalents, and substitutions included in the idea and technical scope of the present disclosure.

Although the terms “first”, “second”, etc., may be used herein to describe various elements, these elements should not be limited by these terms. These terms are only used to distinguish one element from another element.

When an element is referred to as being “coupled”, “connected”, or “linked” to another element, it can be directly coupled or connected to the other element or intervening elements may be present therebetween. In contrast, when an element is referred to as being “directly coupled”, “directly connected”, or “directly linked” to another element, there are no intervening elements present.

As used herein, the singular forms “a”, “an”, and “the” are intended to include the plural forms as well, unless the context clearly indicates otherwise. When a component, device, element, or the like of the present disclosure is described as having a purpose or performing an operation, function, or the like, the component, device, or element should be considered herein as being “configured to” meet that purpose or to perform that operation or function.

It should be further understood that the terms “comprise”, “include”, “have”, etc., when used in this specification, specify the presence of stated features, integers, steps, operations, elements, components, and/or combinations thereof but do not preclude the presence or addition of one or more other features, integers, steps, operations, elements, components, and/or combinations thereof.

For example, a controller may include a communication device communicating with another controller or a sensor to control a corresponding function to which the controller is in charge; a memory storing an operating system (OS), logic commands, input/output information, and the like; and one or more processors performing determination, calculation, decision, and the like required for the control of the corresponding function. Also, it is only a term widely used for naming a controller that controls vehicle-specific functions, and does not mean a generic function unit.

Hereinafter, a headlamp aiming adjustment system for a mobility device and a controlling method for this system according to embodiments of the present disclosure are described with reference to the accompanying drawings.

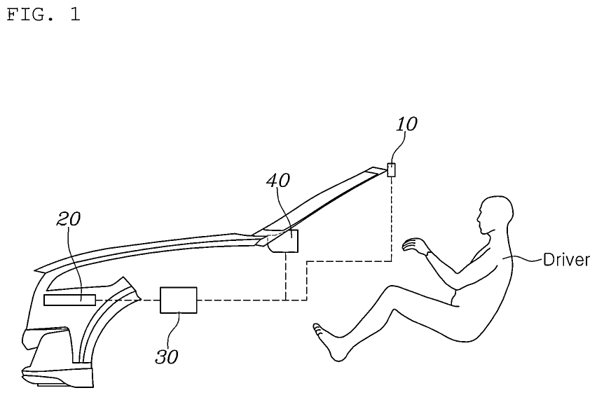

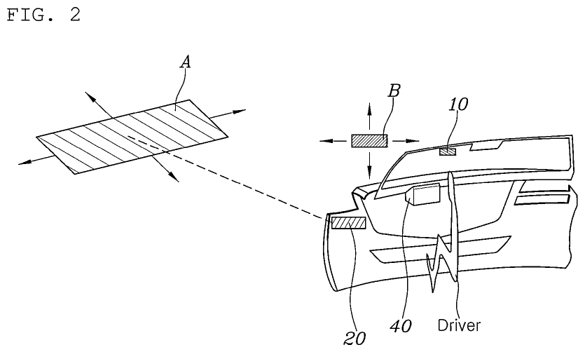

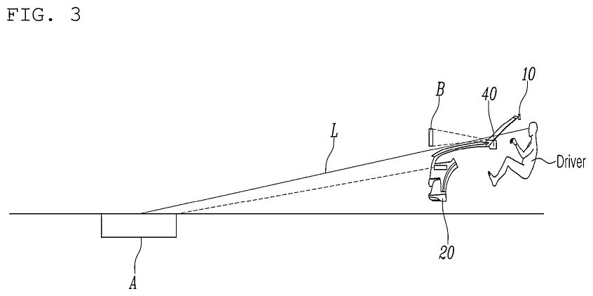

FIG. 1 is a view illustrating the configuration of a headlamp aiming adjustment system for a mobility device according to an embodiment of the present disclosure; FIG. 2 is a view illustrating a projection image and an information image emitted from a projection headlamp and a HUD of the headlamp aiming adjustment system for the mobility device illustrated in FIG. 1; and FIG. 3 is a view illustrating the headlamp aiming adjustment system for the mobility device.

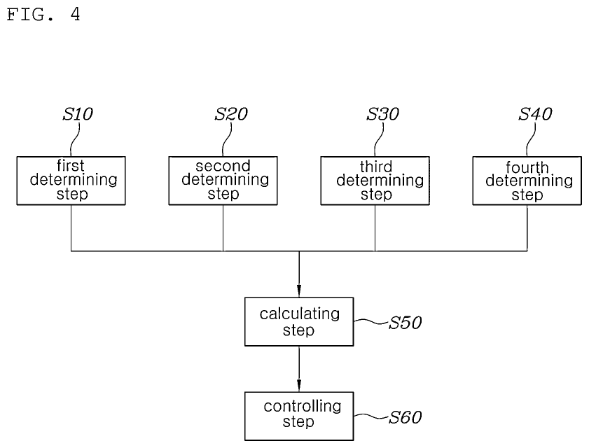

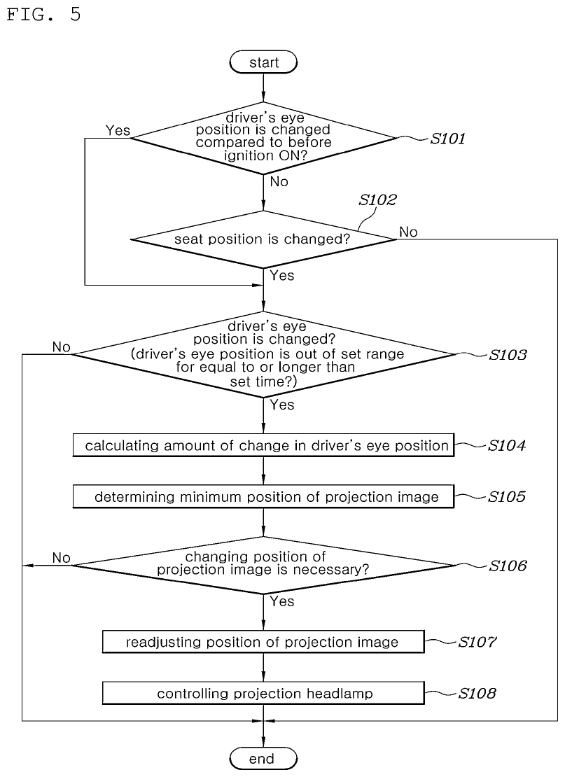

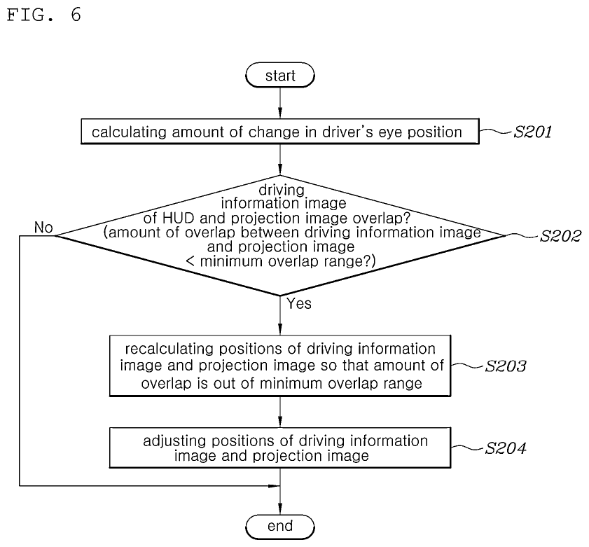

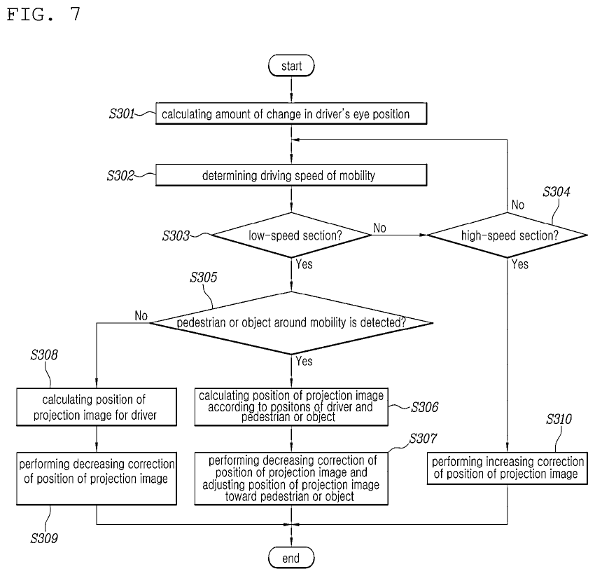

Meanwhile, FIG. 4 is a flowchart illustrating a headlamp aiming adjustment method for a mobility device according to the present disclosure; FIG. 5 is a flow chart illustrating an embodiment of the headlamp aiming adjustment method for the mobility device illustrated in FIG. 4; FIG. 6 is a flowchart illustrating another embodiment of the headlamp aiming adjustment method for the mobility device illustrated in FIG. 4; and FIG. 7 is a flowchart illustrating another embodiment of the headlamp aiming adjustment method for the mobility device illustrated in FIG. 4.

As illustrated in FIGS. 1 to 3, the headlamp aiming adjustment system for the mobility device according to the present disclosure includes: a camera sensing part 10 for determining a driver's eye position; a projection headlamp 20 for emitting light to form a projection image A on a road surface and adjusting a position of the projection image A; and a controller 30 for controlling the projection headlamp 20 to adjust the position of the projection image A of the projection headlamp 20. In particular, the controller 30 adjusts the position of the projection image A by receiving the driver's eye position through the camera sensing part 10 and calculating the position of the projection image A according to the amount of change in the driver's eye position.

The camera sensing part 10 includes a camera installed in the interior of the mobility device and is configured to detect a driver's pupil position by detecting the driver's eye position.

The projection headlamp 20 is configured to emit light to the road surface in a driving direction of the mobility device and form the projection image A including a low beam and a specific message. In addition, the projection headlamp 20 is configured to adjust the position of the projection image A. Accordingly, the projection headlamp 20 may include a light source, a micro-electro-mechanical system (MEMS), an optical lens, and a motor. Since the configuration of the projection headlamp 20 is well-known in the art, a detailed description thereof is omitted.

In particular, according to the present disclosure, the controller 30 receives the driver's eye position detected by the camera sensing part 10 and checks whether the driver's eye position is changed.

When the driver's eye position changes, it could be due to the driver changing their posture or being replaced by someone else. In particular, because the driver's eye position affects the front viewing angle, a viewable position of a light image emitted from the projection headlamp 20 is changed according to the driver's eye position.

In the related art, since the change in the driver's eye position is not taken into account, visibility of the light image generated by the projection headlamp 20 is degraded.

However, in the present disclosure, visibility of the light image is improved by determining the driver's eye position and adjusting the position of the light image generated on the road surface by the projection headlamp 20 according to the amount of change in the driver's eye position.

According to one embodiment of the present disclosure, the controller 30 calculates the position of the projection image A of the projection headlamp 20 according to the amount of change in the driver's eye position when the driver's eye position is changed. And the controller 30 controls the projection headlamp 20 to adjust the position of the projection image A on the road surface to the calculated position of the projection image A.

For example, when the driver's eye position is changed in up and down directions, the controller 30 may adjust the position of the projection image A generated on the road surface to become closer to or farther away from the mobility device. When the driver's eye position is changed in left and right directions, the controller 30 may adjust the position of the projection image A generated on the road surface in the left and right directions with respect to the mobility device.

As described above, by adjusting the position of the projection image A emitted and projected onto the road from the projection headlamp 20 according to the driver's eye position, the position of the projection image A is optimized with respect to the driver and thus visibility of projection image A is improved.

In detail, the controller 30 calculates the position of the projection image A of the projection headlamp 20 according to the amount of change in the driver's eye position if the driver's eye position exceeds a set range for a certain period of time. The certain period of time may be equal to or longer than a set time.

For example, the set time may be set to 3 seconds, and the set range may be set to about 5 mm with respect to a reference position. The set time and set range are provided, in determining the driver's eye position, to adjust the position of the projection image A emitted from the projection headlamp 20 to a position corresponding to a point in time when the driver's eye position is stabilized after the eye position is changed.

When the driver's eye position is out of the set range for the predetermined period of time, which is equal to or longer than the set time, the controller 30 determines that the driver is in a stable state after changing his/her posture. Then, the controller 30 calculates the position of the projection image A according to the amount of change in the driver's eye position, and allows the projection image A to be emitted to the calculated position.

In another embodiment, the controller 30 further receives information about a seat position, and when it is determined that the seat position is changed, the controller 30 calculates the position of the projection image A of the projection headlamp 20 according to the amount of change in the driver's eye position.

The controller 30 receives information about the seat position through a seat positioning sensor. The controller 30 calculates the position of the projection image A of the projection headlamp 20 when the seat position is changed. In other words, when the seat positioning sensor determines that a seat height is changed or a seat has adjusted in forward and backward directions, the controller 30 determines that the driver's eye position is changed according to the seat position and calculates the position of the projection image A.

As described above, by allowing the camera sensing part 10 to detect the driver's eye position when the seat position is changed without constantly checking the driver's eye position during driving of the mobility device, power consumption is reduced and selective control is performed for each situation. In another embodiment, the controller 30 stores the driver's eye position before the ignition of the mobility device is turned off (i.e., ignition OFF). When the ignition is turned on (i.e., ignition ON), if the driver's eye position is different from the previously stored driver's eye position, the controller 30 calculates the position of the projection image A of the projection headlamp 20 according to the amount of change in the driver's eye position.

In other words, if the driver's eye position upon ignition ON is different from the position stored before ignition OFF, it is determined that the driver is changed, or the posture of the driver is changed such as a change in the seat position.

As described above, by comparing the driver's eye position when the mobility device's ignition is turned on with the previously stored driver's eye position, the position of the projection image A emitted from the projection headlamp 20 is adjusted in advance before driving the mobility device, thereby improving reliability.

In another embodiment, the controller 30 derives a virtual line L connecting the driver's eye position and the position of the projection image A. If the virtual line L is at a position where it interferes with a front part of the mobility device, the controller 30 calculates the position of the projection image A of the projection headlamp 20.

As illustrated in FIG. 3, the controller 30 derives the virtual line L connecting the driver's eye position and the position of the projection image A emitted and projected onto the road from the projection headlamp 20. The virtual line L is derived on the basis of the driver's eye position detected by the camera sensing part 10 and an aiming angle of the projection headlamp 20, and may be a viewing angle that is viewable by the driver.

Thus, the controller 30 prevents the virtual line L from interfering with the front part M of the mobility device when adjusting the position of the projection image A emitted from the projection headlamp 20. Here, the front part M of mobility device may include a hood, a windshield, and a steering wheel of the mobility device.

In other words, when the virtual line L is positioned to interfere with the front part M of the mobility device, it is difficult for the driver to identify the projection image A since the front part M of the mobility device exists within the driver's viewing angle.

Accordingly, when the virtual line L is at a position where it interferes with the front part M of the mobility device, the controller 30 calculates the position of the projection image A of the projection headlamp 20 such that the virtual line L no longer interferes with the front part M of the mobility device. In addition, when adjusting the position of the projection image A of the projection headlamp 20 according to the amount of change in the driver's eye position, the controller 30 recalculates, when the virtual line L interferes with the front part M of the mobility device, the position of the projection image A so that the virtual line L does not interfere with the front part M of the mobility device, thereby ensuring visibility of the projection image A for the driver.

In another embodiment, the controller 30 further determines whether positions of an information image B of a head-up display (HUD) 40 and the projection image A of the projection headlamp 20 overlap at the viewing angle according to the driver's eye position.

The HUD 40 displays the information image B in front of the driver's field of view. The HUD 40 may display, for example, various information such as driving information, weather, and surrounding information on a windshield using augmented reality. The HUD 40 is configured to adjust the position of the information image B.

At this time, the controller 30 determines whether the information image B and the projection image A overlap at the driver's eye position on the basis of an emitting angle of the information image B of the HUD 40 and an emitting angle of the projection image A of the projection headlamp 20. When the information image B and the projection image A overlap at the driver's eye position, visibility of each image may be deteriorated and information confusion may occur.

Accordingly, when the positions of the information image B and the projection image A overlap at the viewing angle according to the driver's eye position, the controller 30 calculates the amount of overlap between the information image B and the projection image A and controls the HUD 40 and the projection headlamp 20 so that the amount of overlap is out of a minimum overlap range.

The size of each of the information image B of the HUD 40 and the projection image A of the projection headlamp 20 is determined according to an initial design, and a size change is derived according to position adjustment.

Thus, the controller 30 calculates the amount of overlap between the position of the information image B and the projection image A positioned at the viewing angle according to the driver's eye position. In particular, the controller 30 stores the minimum overlap range in which the information image B and the projection image A are distinguished, and controls the HUD 40 and the projection headlamp 20 so that the amount of overlap between the information image B and the projection image A is out of the minimum overlap range.

In other words, the controller 30 adjusts aiming of the HUD 40 and the projection headlamp 20 so that the amount of overlap between the information image B and the projection image A is out of the minimum overlap range. Thus, the information image B and the projection image A are distinguished without overlapping at the viewing angle of the driver, thereby enabling the driver to easily identify each image information.

At this time, when controlling the HUD 40 and the projection headlamp 20 on the basis of the calculated amount of overlap, the controller 30 first adjusts the position of the projection image A of the projection headlamp 20, and then when the amount of overlap is not out of the minimum overlap range even when the position of the projection image A is adjusted, the controller 30 adjusts the position of the information image B of the HUD 40.

While the projection headlamp 20 adjusts the position of the projection image A in a wider range compared to the HUD 40, the HUD 40 adjusts the position of the information image B in a relatively narrow range.

Accordingly, when calculating the amount of overlap between the information image B and the projection image A, the controller 30 gives priority to adjusting the position of the projection image A of the projection headlamp 20. When the amount of overlap is not out of the minimum overlap range even after the position of the projection image A has been adjusted, the controller 30 adjusts the position of the information image B of the HUD 40.

Thus, the information image B of the HUD 40 and the projection image A of the headlamp 20 are distinguished at the viewing angle of the driver, thereby enabling the driver to accurately recognize each image information.

Meanwhile, the controller 30 calculates the position of the projection image A of the projection headlamp 20 according to the amount of change in the driver's eye position when the mobility device is stopped or driven at less than a set speed.

In one embodiment, the controller 30 may receive driving speed information of the mobility device through a speed sensor. The set speed may be set to 30 km/h.

When the mobility device is stopped or driven at less than the set speed, the controller 30 calculates the position of the projection image A according to the amount of change in the driver's eye position and controls the projection headlamp 20 to adjust the position of the projection image A to the calculated position. By adjusting the position of the projection image A in a stable driving state, i.e., a state in which the mobility device is stopped or driven at less than the set speed, dispersion of the driver's gaze during high-speed driving is prevented and reliability is improved.

In addition, the controller 30 corrects the position of the projection image A of the projection headlamp 20 by dividing a driving speed of the mobility device into a low-speed section and a high-speed section during driving.

In other words, the controller 30 adjusts the position of the projection image A generated on the road surface by the projection headlamp 20 according to the driving speed of the mobility device, thereby improving visibility of the projection image A through the position of the projection image A optimized for a current driving speed of the mobility device.

For example, the term “low-speed section” may refer to a situation in which the mobility device is driven in a city at speeds equal to or higher than 40 km/h, while the term “high-speed section” may refer to a situation in which the mobility device is driven on a highway at speeds equal to or higher than 100 km/h.

In the low-speed section, pedestrians or oncoming mobilities along with the driver of the mobility device recognize a message according to the projection image A generated by the projection headlamp 20, so that safe driving is achieved.

In addition, in the high-speed section, the position of the projection image A generated by the projection headlamp 20 is determined for the driver of the mobility device. Thus, the driver recognizes a message according to the projection image A in a high-speed driving situation, so that driving stability is ensured.

In detail, when the mobility device is driven in the low-speed section, the controller 30 receives sensing information through an external sensing part that detects an object and a pedestrian around the mobility device and calculates the position of the projection image A of the projection headlamp 20 according to positions of the detected object and pedestrian.

Here, the external sensing part may include a camera or a laser sensor. The external sensing part detects an object or pedestrian around the mobility device and transmits the corresponding information to the controller 30.

When the mobility device is driven in the low-speed section, the controllers 30 determines the position of the object or pedestrian received from the external sensing part, and calculates the position of the projection image A of the projection headlamp 20 according to the viewing angle of the driver and the position of the object or pedestrian.

When the mobility device is driven in the low-speed section, the controller 30 performs decreasing correction so that the position of the projection image A becomes closer to the mobility device.

In other words, when the pedestrian is detected through the external sensing part in a situation in which the mobility device is driven in the low-speed section, the controller 30 controls the projection headlamp 20 to project a projection image A onto the road surface, the projection image A including a message notifying the driver that the pedestrian exists around the mobility device and a message notifying the pedestrian that the mobility device is driven around the pedestrian.

As described above, the controller 30 adjusts the position of the projection image A to become closer to the mobility device and adjusts the position of the projection image A toward the pedestrian detected around the mobility device during driving of the mobility device in the low-speed section, thereby enabling both the driver and the pedestrian to identify the projection image A and the corresponding message.

In another embodiment, when the mobility device is driven in the low-speed section, the controller 30 adjusts the position of the projection image A to become closer to the mobility device, and when an object is detected in front of the mobility device, the controller 30 adjusts the position of the projection image A toward the object, thereby enabling the driver to recognize the object. Thus, safe driving is achieved.

As described above, the controller 30 calculates the position of the projection image A generated on the road surface by the projection headlamp 20 according to whether the mobility device is driven in the low-speed section and whether the pedestrian or object is detected, thereby enabling both the driver and the pedestrian to identify the projection image A and the corresponding message. Thus, driving stability is ensured.

Meanwhile, when the mobility device is driven in the high-speed section, the controller 30 performs increasing correction so that the position of the projection image A becomes farther away from the mobility device as the driving speed of the mobility device increases.

When the mobility device is driven in the high-speed section, the controller 30 performs increasing correction, and adjusts the position of the projection image A to become farther away from the mobility device in proportion to the increase in the driving speed of the mobility device.

That is, the driver has to have a wide front field of view when the mobility device is driven in the high-speed section. Accordingly, the controller 30 performs increasing correction during driving of the mobility device in the high-speed section to adjust the position of the projection image A generated by the projection headlamp 20 to become farther away from the mobility device, thereby enabling the driver to easily identify the projection image A and the corresponding message.

Thus, the driver recognizes the projection image A even in a high-speed driving situation, so that safe driving is achieved.

Meanwhile, as illustrated in FIG. 4, a headlamp aiming adjustment method for a mobility device according to the present disclosure includes: a first determining step (S10) of determining a driver's eye position and determining whether the driver's eye position is changed; a second determining step (S20) of determining a position of a projection image A emitted from a projection headlamp 20; a calculating step (S50) of calculating the position of the projection image A according to the amount of change in the driver's eye position when it is determined that the driver's eye position is changed; and a controlling step (S60) of controlling the projection headlamp 20 to emit light to the calculated position of the projection image A.

As described above, by adjusting the position of the projection image A emitted and projected onto the road from the projection headlamp 20 according to the driver's eye position, the position of the projection image A is optimized with respect to the driver and thus visibility of projection image A is improved.

In one embodiment, as illustrated in FIG. 5, in the first determining step S10, the driver's eye position before ignition OFF is stored, and when the driver's eye position upon ignition ON is different from the previously stored driver's eye position, it is determined that the driver's eye position is changed (S101).

As described above, by comparing the driver's eye position when mobility device ignition is turned on with the previously stored driver's eye position, the position of the projection image A emitted from the projection headlamp 20 is adjusted in advance before driving of the mobility device, thereby improving reliability.

In addition, in the first determining step S10, information about a seat position is further received, and when it is determined that the seat position is changed, it is determined that the driver's eye position is changed (S102).

The position of the projection image A of the projection headlamp 20 is calculated when the seat position is changed. In other words, when it is determined that a seat height is changed or a seat has adjusted in forward and backward directions, it is determined that the driver's eye position is changed according to the seat position and the position of the projection image A is calculated.

In addition, in the first determining step S10, when the driver's eye position is out of a set range for a certain period equal to or longer than a set time, it is determined that the driver's eye position is changed (S103).

When the driver's eye position is out of the set range for a period equal to or longer than the set time, it is determined that the driver is in a stable state after changing his/her posture, the position of the projection image A is calculated according to the amount of change in the driver's eye position, and the projection image A is emitted to the calculated position.

When it is determined that the seat position is changed, the position of the projection image A of the projection headlamp 20 is calculated according to the amount of change in the driver's eye position (S104).

At this time, a virtual line L connecting the driver's eye position and the position of the projection image A is derived, and it is determined whether the virtual line L is at a position where it interferes with a front part M of the mobility device. In particular, a minimum position at which the projection image A is viewable at a viewing angle of the driver is determined (S105). This is to prevent the virtual line L from interfering with the front part M of the mobility device by calculating the viewing angle of the driver and the position of the projection image A of the projection headlamp 20.

When the virtual line L interferes with the front part M of the mobility device, it is determined whether the position of the projection image A needs to be changed. When the position of the projection image A needs to be changed, aiming of the projection headlamp 20 is readjusted by recalculating the position of the projection image A so that the virtual line L does not interfere with the mobility device (S106 to S107).

When the position of the projection image A is finally calculated, aiming of the projection headlamp 20 is adjusted so that the projection image A is generated on the road (S108).

In another embodiment, the headlamp aiming adjustment method further includes a third determining step S30 of determining a position of an information image B displayed through a HUD 40.

As illustrated in FIG. 6, the position of the projection image A is calculated according to the amount of change in the position of the occupant's eye (S201).

In addition, in the calculating step S50, positions of the information image B and the projection image A overlap at the viewing angle according to the driver's eye position (S202). In detail, it is determined whether the amount of overlap between the information image B and the projection image A is included in a minimum overlap range.

When the positions of the information image B and the projection image A overlap at the viewing angle according to the driver's eye position, the positions of the information image B and the projection image A are recalculated so that the amount of overlap is out of the minimum overlap range (S203). When the positions of the information image B and the projection image A are calculated, aiming of the HUD 40 and the projection headlamp 20 is adjusted to adjust the positions of the information image B and the projection image A (S204).

In another embodiment, the headlamp aiming adjustment method further includes a fourth determining step S40 of receiving driving speed information of the mobility device and determining whether the driving speed of the mobility device is in a low-speed section or a high-speed section.

As illustrated in FIG. 7, the position of the projection image A is calculated according to the amount of change in the position of the occupant's eye (S301).

At this time, the driving speed of the mobility device is determined, and it is determined whether the driving speed of the mobility device is in the low-speed section or the high-speed section (S302 to S304).

When the driving speed of the mobility device is in the low-speed section, an object or pedestrian around the mobility device is detected (S305).

When the mobility device is driven in the low-speed section and the object or pedestrian around the mobility device are detected, the position of the projection image A of the projection headlamp 20 is calculated according to the viewing angle of the driver and the position of the object or pedestrian (S306). Thus, decreasing correction is performed and the position of the projection image A of the projection headlamp 20 is adjusted toward the object or pedestrian (S307).

When the object or pedestrian is not detected during driving of the mobility device in the low-speed section, the position of the projection image A of the projection headlamp 20 is calculated for the driver (S308). Thus, decreasing correction is performed and the position of the projection image A of the projection headlamp 20 is adjusted toward the driver (S309).

Meanwhile, when the mobility device is driven in the high-speed section, increasing correction is performed so that the position of the projection image A becomes farther away from the mobility device as the driving speed of the mobility device increases (S310).

In other words, the driver has to have a wide front field of view when the mobility device is driven in the high-speed section. Accordingly, increasing correction is performed during driving of the mobility device in the high-speed section to adjust the position of the projection image A generated by the projection headlamp 20 to become farther away from the mobility device, thereby enabling the driver to easily identify the projection image A and the corresponding message.

According to the headlamp aiming adjustment system and method for the mobility device having the configuration as described above, by adjusting the emitting position of light emitted from the projection headlamp and the position of the information image displayed through the HUD according to the driver's eye position, visibility of messages delivered through the projection headlamp and the HUD is improved.

Although specific embodiments of the present disclosure have been described for illustrative purposes, those having ordinary skill in the art should appreciate that various modifications, additions, and substitutions are possible, without departing from the scope and spirit of the present disclosure as discussed above.

What is claimed is:

1. A headlamp aiming adjustment system for a mobility device, the system comprising:
a camera sensing part configured to detect an eye position of a driver of the mobility device;
a projection headlamp configured to emit light to form a projection image on a road surface and to adjust a position of the projection image; and
a controller configured to control the projection headlamp to adjust the position of the projection image of the projection headlamp by receiving the eye position through the camera sensing part and calculating the position of the projection image according to an amount of change in the eye position.

2. The system of claim 1, wherein the controller is configured to calculate the position of the projection image of the projection headlamp according to the amount of change in the eye position when the eye position is out of a set range for a period of time equal to or longer than a set time.

3. The system of claim 1, wherein the controller is further configured to receive information about a seat position, and when the seat position is changed, the controller is configured to calculate the position of the projection image of the projection headlamp according to the amount of change in the eye position.

4. The system of claim 1, wherein the controller is configured to store the eye position before an ignition of the mobility device is turned off, and
wherein the ignition is turned on and the eye position upon is different from the stored eye position, the controller is configured to calculate the position of the projection image of the projection headlamp according to the amount of change in the eye position.

5. The system of claim 1, wherein the controller is configured to derive a virtual line connecting the eye position and the position of the projection image, and when the virtual line is at a position where the virtual line interferes with a front part of the mobility device, the controller is configured to calculate the position of the projection image of the projection headlamp.

6. The system of claim 1, further comprising a head-up display (HUD) configured to display an informational image in front of a field of view of the driver,
wherein the controller is further configured to determine whether positions of the information image of the HUD and the projection image of the projection headlamp overlap at a viewing angle according to the eye position.

7. The system of claim 6, wherein when the positions of the information image and the projection image overlap at the viewing angle, the controller is configured to calculate an amount of overlap between the information image and the projection image and control the HUD and the projection headlamp so that the amount of overlap is out of a minimum overlap range.

8. The system of claim 7, wherein when controlling the HUD and the projection headlamp based on the calculated amount of overlap, the controller is configured to first adjust the position of the projection image of the projection headlamp, and then when the amount of overlap is not out of the minimum overlap range even when the position of the projection image has been adjusted, the controller is configured to adjust the position of the information image of the HUD.

9. The system of claim 1, wherein the controller is configured to calculate the position of the projection image of the projection headlamp according to the amount of change in the eye position when the mobility device is stopped or driven at a speed less than a set speed.

10. The system of claim 1, wherein the controller is configured to correct the position of the projection image of the projection headlamp by dividing a driving speed of the mobility device into a low-speed section and a high-speed section during driving.

11. The system of claim 10, wherein when the mobility device is driven in the low-speed section, the controller is configured to receive sensing information through an external sensing part that is configured to detect an object and a pedestrian around the mobility device, and the controller is configured to calculate the position of the projection image of the projection headlamp according to positions of the detected object and pedestrian.

12. The system of claim 11, wherein when the mobility device is driven in the low-speed section, the controller is configured to perform decreasing correction so that the position of the projection image becomes closer to the mobility device.

13. The system of claim 10, wherein when the mobility device is driven in the high-speed section, the controller is configured to perform increasing correction so that the position of the projection image becomes farther away from the mobility device as the driving speed of the mobility device increases.

14. A headlamp aiming adjustment method for a mobility device, the method comprising:
determining an eye position of a driver of the mobility device and determining whether the eye position is changed;
determining a position of a projection image emitted from a projection headlamp;
calculating the position of the projection image according to an amount of change in the eye position when the eye position is changed; and
controlling the projection headlamp to emit light to the calculated position of the projection image.

15. The method of claim 14, wherein determining the eye position includes determining that the eye position is changed when the eye position is out of a set range for a period of time equal to or longer than a set time.

16. The method of claim 14, wherein determining the eye position includes:
receiving information about a seat position, and
when the seat position is changed, determining that the eye position is changed.

17. The method of claim 14, wherein determining eye position includes:
storing the eye position before an ignition of the mobility device is turned off, and
when the ignition is turned on and the eye position is different from the stored eye position, determining that the eye position is changed.

18. The method of claim 14, wherein calculating the position of the projection image includes:
deriving a virtual line connecting the eye position and the position of the projection image, and
when the virtual line is at a position where the virtual line interferes with a front part of the mobility device, calculating the position of the projection image of the projection headlamp so that the virtual line does not interfere with the front part of the mobility device.

19. The method of claim 14, further comprising determining a position of an information image displayed through a a head-up display (HUD),
wherein calculating the position of the projection image includes: when positions of an information image and the projection image overlap at a viewing angle according to the eye position, calculating an amount of overlap to be out of a minimum overlap range.

20. The method of claim 14, further comprising: receiving driving speed information of the mobility device and determining whether the driving speed of the mobility device is in a low-speed section or a high-speed section,
wherein when the mobility device is driven in the low-speed section, performing decreasing correction so that the position of the projection image becomes closer to the mobility device.

21. The method of claim 20, wherein when the mobility device is driven in the high-speed section, performing increasing correction so that the position of the projection image becomes farther away from the mobility device as the driving speed of the mobility device increases.
